(19) United States
(12) Patent Application Publication
(10) Pub. No.: US 2015/0152783 A1
(43) Pub. Date: Jun. 4, 2015

(54) COMBINATION OF TWO GAS TURBINES TO DRIVE A LOAD

(71) Applicant: Nuovo Pignone Srl, Florence (IT)

(72) Inventor: Gianni Acquisti, Arezzo (IT)

(21) Appl. No.: 14/406,239

(22) PCT Filed: Jun. 6, 2013
(86) PCT No.: PCT/EP2013/061743

§ 371 Date: Dec. 8, 2014

(30) Foreign Application Priority Data
Jun. 8, 2012 (IT) FI2012A000112

(51) Int. Cl. F02C 3/107

(52) U.S. Cl. CPC F02C 3/107

(57) ABSTRACT

A system for driving a load, the system including a first gas turbine having a cold end and a hot end, and a second gas turbine having a cold end and a hot end. The first gas turbine is mechanically connected to the load at the hot end thereof and the second gas turbine is mechanically connected to the load at the cold end thereof.

### FIELD OF THE INVENTION

The embodiments disclosed relate generally to land-based gas turbines. More specifically, the embodiments relate to combined gas turbines for driving rotary machines, such as electric generators or compressors.

### DESCRIPTION OF THE RELATED ART

Gas turbines are commonly used in land-based applications, e.g. as mechanical power generators for driving a large variety of operating machines. With the broad term “land-based” are indicated all applications except aeronautical applications. More specifically, gas turbines are used to rotate electric generators in electric power generation plants. Gas turbines are commonly used also to drive large rotary machinery, such as axial or centrifugal compressors. Typically gas turbines are applied in the field of natural gas liquefaction (LNG), CO₂ recovery and other sectors of the gas industry.

In some known embodiments, heavy duty gas turbines are used. These machines provide high power output but are particularly heavy and cumbersome.

Land-based application of aeroderivative gas turbines is becoming more and more popular in several fields, including LNG and power generation. Aeroderivative gas turbines are characterized by compact dimensions and are therefore particularly useful in off-shore applications. The power output of aeroderivative gas turbines is, however, limited if compared to power rate of a heavy duty gas turbine. Typical power ranges for an aeroderivative gas turbines are up to 60 MW, whereas a heavy duty gas turbine produces beyond 100 MW.

It has become standard practice to combine two gas turbines to power one driven equipment or load, to supply sufficient power to drive the load.

FIG. 1 shows a state-of-the-art application of a twin arrangement of gas turbines to drive a single driven equipment, such as e.g. a turbo-compressor. According to this arrangement, a first gas turbine 1 is provided, including a gas generator 2 and a low pressure turbine 3. An output shaft 4 is connected to a generic driven equipment 5. The driven equipment 5 can comprise a turbomachinery, such as a centrifugal or axial compressor, or an electric generator or the like. The gas generator 2 in turn comprises an axial compressor 2A and a high pressure turbine 2B. The power generated by the high pressure turbine 2B drives the compressor 2A. The gases generated by the gas generator exiting the high pressure turbine 2B drive the low pressure turbine 3 into rotation and the mechanical power generated by the low pressure turbine 3 is used to drive the driven equipment 5. The arrangement of FIG. 1 further includes a second gas turbine 6. The second gas turbine 6 is arranged substantially symmetrically to the first gas turbine 1 and comprises a second gas generator 7 and a second low pressure turbine 8. The gas generator 7 comprises in turn a compressor 7A and a high pressure turbine 7B. The power generated by the low pressure turbine 8 is used to drive the driven equipment 5 via a shaft 9 and a gearbox 10. The interposition of the gearbox 10 is required to reverse the direction of rotation of shaft 9, such that the output shaft 9A of the gearbox 10 rotates in the same direction as the shaft 4 of the first gas turbine 1.

The arrangement allows driving an equipment 5 which requires twice the power provided by a single gas turbine. This known arrangement has some drawbacks. The gearbox 10 dissipates a fraction of the input power, typically in the range of 1-3%, thus reducing the overall efficiency of the plant. Additionally, the footprint of the plant is made larger by the gearbox 10. The use of gearboxes increases lubricating oil consumption and reduces availability of the entire plant, due to possible gearbox failure. Gearboxes, moreover, introduce shaft vibrations which render the rotodynamic behavior of the system critical.

### SUMMARY

By providing a system with a first gas turbine and a second gas turbine arranged such that the cold end of one of said gas turbines faces the hot end of the other one of said gas turbines, and arranging the load therebetween, the load can be connected to the two gas turbines so that the rotational direction of both gas turbines is consistent with the rotational direction of the load without the need for a gearbox arranged between one of the gas turbines and the load.

In some exemplary embodiments the first gas turbine has a first axial shaft extending from the cold end to the hot end across the length of the gas turbine. Similarly, the second gas turbine has a second axial shaft extending from the cold end to the hot end across the length of the second gas turbine. The first axial shaft and the second axial shaft are power shafts driven into rotation by the first low pressure turbine and the second low pressure turbine of the first gas turbine and second gas turbine, respectively, and are capable of transmitting the power produced by the gas turbines, and available on the power shafts, to the load. The load is then directly connected to one end of the first shaft and to the opposing end of the second shaft, being accessible from the respective cold end of the first gas turbine and the hot end of the second gas turbine or vice-versa.

In an embodiment, the load is a variable load that is a load having a variable range of power absorbed, i.e. a compressor; for this reason, the terms “load” and “variable load” are considered as synonyms in the specification. If the load rotates at the same speed as the gas turbines, no gearbox is required between the load and either one of the two gas turbines. Gearboxes are thus entirely dispensed with, removing the above mentioned drawbacks connected with the use of gearboxes. If a rotational speed ratio different than “1” is required between the gas turbines and the load, gear boxes are arranged between each gas turbine and the load. However, a reversal of the rotational direction of the output shaft of the gas turbines is not required.

Based on the above concept, according to an exemplary embodiment, a system for driving a load is provided, comprising: a first gas turbine having a cold end and a hot end; a second gas turbine having a cold end and a hot end; a plurality of clutch joints, wherein at least one clutch joint of said plurality of clutch joints mechanically connects said variable load at the hot end of said first gas turbine and at least a further clutch joint of said plurality of clutch joints mechanically connects said variable load at the cold end of said second gas turbine; a control system arranged to control said plurality of clutch joints in order to regulate the mechanical power transmission from said first and/or second gas turbines and said variable load.The hot end of a gas turbine is understood as the end where the low pressure turbine and the exhaust gas discharge plenum are arranged. The cold end of a gas turbine is understood as the end opposite the hot end, i.e. the gas turbine end where the first air compressor and the air intake plenum of the gas generator are arranged.

In an embodiment, the first gas turbine and the second gas turbine are substantially equal to one another. In particularly advantageous embodiments the gas turbines are aeroderivative gas turbines. The reduced weight and dimensions of aeroderivative gas turbines and the special arrangement with the load placed between the hot end of one gas turbine and the cold end of the other gas turbine results in a compact arrangement, particularly suitable for instance in off-shore applications.

According to some exemplary embodiments, the first gas turbine comprises a first shaft extending from the cold end to the hot end of the first gas turbine and the second gas turbine comprises a second shaft extending from the cold end to the hot end of the second gas turbine. The first shaft and said second shaft are mechanically connected to load through said plurality of clutch joints. In the present case, when the clutch joint connects the load to the gas turbine shaft, in an embodiment, the load shaft and the gas turbine shaft rotate at the same rotational speed. According to a further aspect, the subject disclosed herein also relates to a method for driving a load by means of gas turbines, comprising the steps of: arranging a first gas turbine having a hot end and a cold end; arranging a second gas turbine having a hot end and a cold end; providing a plurality of clutch joints arranged to connect or disconnect said first and/or second gas turbines to said variable load; rotating the first gas turbine, the second gas turbine and the variable load in a same rotation direction; and selectively driving said variable load with one of said first gas turbine and second gas turbine, or with both of said first gas turbine and second gas turbine, controlling said plurality of clutch joints.

The above brief description sets forth features of various embodiments of the present invention in order that the detailed description that follows may be better understood and in order that the present contributions to the art may be better appreciated. There are, of course, other features of the invention that will be described hereinafter and which will be set forth in the appended claims. In this respect, before explaining several embodiments of the invention in details, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 schematically illustrates an arrangement of two gas turbines for driving a common load, according to the state of the art;

FIG. 2 schematically illustrates an arrangement of two gas turbines for driving a common load according to one embodiment of the subject matter disclosed herein;

FIG. 3 illustrates a longitudinal section of an aeroderivative gas turbine suitable for use in an arrangement according to FIG. 2;

FIG. 4 schematically illustrates a further arrangement of two gas turbines for driving a common load.

### DETAILED DESCRIPTION

The following detailed description of the exemplary embodiments refers to the accompanying drawings. The same reference numbers in different drawings identify the same or similar elements. Additionally, the drawings are not necessarily drawn to scale. Also, the following detailed description does not limit the invention. Instead, the scope of the invention is defined by the appended claims.

Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

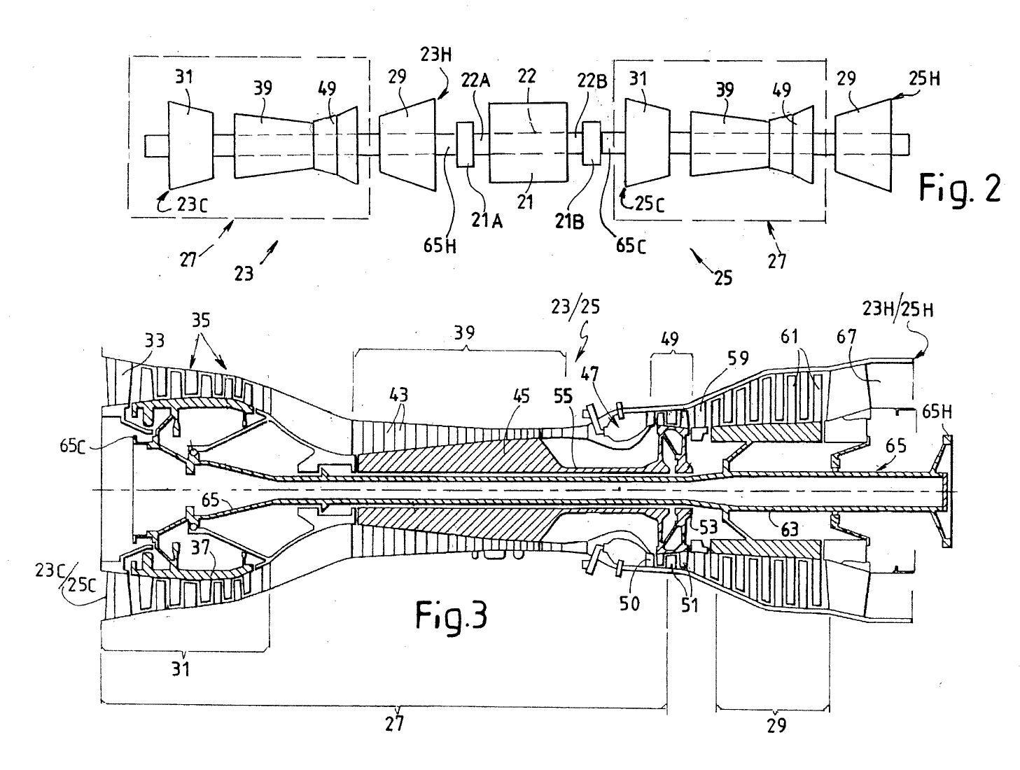

FIG. 2 illustrates an arrangement according to the subject matter disclosed herein. According to this embodiment a load 21 comprising a load shaft 22 is driven in rotation by a twin arrangement of two gas turbines 23 and 25. According to some embodiments the two gas turbines 23 and 25 are identical one to the other. In some embodiments the gas turbines 23 and 25 are aeroderivative gas turbines. In an exemplary embodiment the gas turbines 23 and 25 are LM6000 aeroderivative gas turbines available from GE Aviation, Evendale, Ohio, USA, which is a subsidiary of the General Electric Company, Fairfield, Conn., USA.

In some embodiments each gas turbine 23 and 25 comprises a gas generator section 27 and a low pressure, power turbine 29. FIG. 3 illustrates a longitudinal section of one of the gas turbines 23, 25 in more detail. The gas generator section 27 includes a low-pressure axial compressor 31 with a set of stationary inlet blades 33 at the suction side. A plurality of low-pressure compression stages 35 are arranged downstream of the stationary inlet blades 33. Each low-pressure compression stage 35 comprises a set of rotary blades and a set of stationary blades. The rotary blades are supported by a low-pressure compressor rotor 37 and the stationary blades are supported by an outer casing.

The low-pressure axial compressor 31 is in fluid communication with a high-pressure axial compressor 39 arranged downstream of the low-pressure axial compressor 31. The high-pressure axial compressor 39 comprises a plurality of high-pressure compression stages 43. Each high-pressure compression stage 43 comprises a set of rotary blades and a set of stationary blades. The rotary blades are supported by a high-pressure compressor rotor 45. The stationary blades are supported by the casing.

The outlet of the high-pressure axial compressor 39 is in fluid communication with a combustor 47. Compressed air from the high-pressure axial compressor 39 flows into said combustor 47 and gaseous or liquid fuel is mixed therewith and the airfuel mixture is ignited to generate compressed, hot combustion gases.

Downstream of the combustor 47 a first, high-pressure turbine 49 is arranged in fluid communication with the combustor 47. The high-pressure turbine 49 includes a set of stationary inlet blades 50 followed by one or more expansion stages 51, each including a set of stationary blades and a set of rotary blades. The rotary blades are supported by a high-pressure turbine rotor 53. The high-pressure turbine rotor 53 and the high-pressure compressor rotor 45 are supported by and torsionally constrained to a gas-generator shaft 55.

Expansion of the combustion gases flowing from the combustor 47 through the high-pressure turbine 49 generates mechanical power which drives gas-generator shaft 55 and is used to power the high-pressure axial compressor 39.

The outlet of the high-pressure turbine 49 is in fluid communication with the inlet of the low-pressure turbine 29. The combustion gases flowing through the high-pressure turbine 49 are only partly expanded and their expansion continues in the low-pressure turbine 29. The inlet of the low-pressure turbine 29 includes a set of stationary blades 59 supported by the casing of the machinery, followed by a plurality of low-pressure expansion stages 61. Each low-pressure expansion stage 61 includes a set of rotary blades and a set of stationary blades. The rotary blades are supported by a low-pressure turbine rotor 63 and the stationary blades are supported by the casing of the gas turbine 23, 25. The low-pressure turbine rotor 63 is rotationally constrained to and supported by a power shaft 65. The power shaft 65 extends through the gas turbine and coaxially to the gas generator shaft 55. The low-pressure compressor rotor 37 is supported by and constrained to the same power shaft 65.

The combustion gases expanding in the low-pressure turbine 29 generate mechanical power on the power shaft 65, which is partly used to drive the low-pressure axial compressor 31 and partly used to drive the load 21.

As can be appreciated from FIG. 3, the power shaft 65 extends from a first end 65C to an opposite second end 65H. The first end 65C of the power shaft 65 is arranged at the so-called cold end 23C, 25C of the gas turbine 23, 25, i.e. at the cold air inlet side thereof. The second end 65H is arranged at the so-called hot end 23H, 25H of the gas turbine 23, 25, i.e. at the side wherefrom the exhausted hot combustion gases are discharged at 67, after they have been expanded and at partly cooled-down in the high-pressure turbine 49 and the low-pressure turbine 29.

The power shaft 65 can thus be connected to the load 21 on either the first end 65C on the cold side of the gas turbine 23, 25 or on the second end 65H on the hot side of the gas turbine 23, 25. The hot end 65H and the cold end 65C can be combined with a load coupling for this purpose.

Turning now again to FIG. 2, in this exemplary embodiment the gas turbine 23 is connected to the load 21 through the second end 65H of the respective power shaft 65, i.e. on the hot end of the gas turbine 23. Conversely, the gas turbine 25 is connected to the load 21 through the first end 65C of the respective power shaft 65, i.e. on the cold end of the gas turbine 23.

The two gas turbines 23, 25 are therefore connected to the same load 21 directly, without the need for a gearbox reversing the direction of the rotational motion, since the two gas turbines 23, 25 are oriented in the same direction and connected at opposite sides to the load 21.

As noted above, the load 21 can be a turbomachinery, such as an axial or a centrifugal compressor, e.g. a refrigerant compressor for an LNG plant, or a compressor for CO₂ recovery and liquefaction, a rotary pump or the like. In other embodiments the load 21 can be an electric generator, for the production of electric energy or any other load having a rotary shaft which is driven into rotation by the two gas turbines 23, 25 acting as a set of twin drivers for the common load. The term load as used herein shall be understood as possibly including more than one rotary machine. For example the load can comprise a compressor train, i.e. two or more coaxially arranged compressors, and/or two or more electric machines. In some embodiments, the load can also comprise two or more rotary machines of different nature, e.g. a turbomachine and an electric machine.

In an embodiment, as schematically shown in FIG. 2, the load 21 can comprise a through shaft having opposing ends 22A, 22B which are connected to the two opposing ends 65H and 65C of shafts 65 of the first gas turbine 23 and the second gas turbine 25, respectively, with the interposition of respective joints labeled 21A and 21B respectively. The joints 21A, 21B can make up for possible misalignments of the opposing shafts 65, which are generally parallel and coaxial. One or both joints 21A, 21B can also include a clutch or be combined to a clutch joint, to selectively connect or disconnect one or both turbine shafts 65 to and from the load 21.

In an embodiment, a control system is provided to control said plurality of clutch joints. Said clutch joints 21A, 21B can operate to connectdisconnect said gas turbine shaft/s to the load.

The control system is arranged to selectively operates said plurality of clutch joints in function of the rotational speed of at least one of said first, second gas turbine (23; 123; 25; 125) and said variable load (21; 120), in order to regulate the mechanical power transmission from said first and/or second gas turbines (23; 123; 25; 125) and said variable load (21; 120).

A regulation of the mechanical power transmission from turbines to the load (21; 120) allows to optimize the overall consumption.

In particular, the control system manages the starting phase of the train composed by the load 21 and the first and second gas turbines 23, 25.

Initially, the load 21 can be connected only with the first gas turbine 23, and the first gas turbine 23 can start to rotate driving the load 21. In the while, the second gas turbine 25 can start to rotate in order to reach the same rotational speed of said first gas turbine 23 and load 21.

Once the speeds are substantially equals, the second gas turbine 25 can be connected to the load 21.

The same result can be achieved starting the second gas turbine 25 and the load 21, and then connecting the rotating first gas turbine 23. In the exemplary embodiment shown in the drawing the connection between the turbine shafts 65 and the load 21 is a direct connection, i.e. the load shaft 22 and the two turbine shafts 65 rotate at substantially the same speed. In other embodiments, not shown, a respective gearbox can be arranged between each power shaft 65 and the corresponding end of the load shaft 22. This modified arrangement can be used when the rotary speed of the turbines 23, 25 is different than the rotary speed of the load 21. A gearbox reversing the rotation direction of one of the two turbine shafts 65 will however not be required.

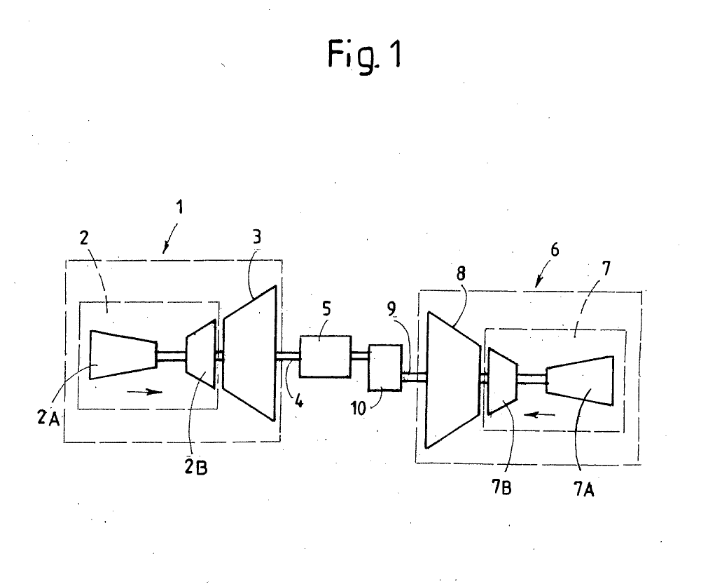

As can be appreciated by comparing FIGS. 1 and 2, the overall dimension of the arrangement in FIG. 2 is smaller than that of FIG. 1. Specifically, the footprint of the arrangement in FIG. 2 is smaller due to the absence of the gearbox. The absence of a gearbox also increases the overall efficiency of the plant, since the mechanical losses in the gearbox are eliminated. Lubrication oil consumption is reduced and roto-dynamic criticalities caused by the gearbox are removed as well. The overall plant reliability is enhanced, due to the elimination of a component which is prone to failure.

With respect to a heavy-duty turbine arrangement, using only one turbine to drive the load, the combination of two smaller gas turbines, especially two aeroderivative gas turbines, in a tandem arrangement as disclosed herein allows additional advantages to be achieved. The overall dimensions and footprint of a heavy duty gas turbine and load arrangement are usually larger than a double gas turbine arrangement as the one disclosed herein, the output power being the same. Maintenance of the smaller aeroderivative gas turbines is easier and less expensive than maintenance of a large heavy duty turbine. Moreover, using two separate gas turbines allows a higher flexibility in operation, enabling e.g. a 50 MW load step, while if a single larger gas turbine is used, a 100 MW load step only is possible. Additionally, the power output of each one of the two turbines can be modulated depending upon need, and can be controlled so as to optimize the efficiency of the gas turbines. Using clutch joints between the load and at least one, and, in an embodiment, both gas turbines allows at least one, or, in an embodiment, both, gas turbines to be separated from the load and selectively turned off, if reduced power is required. Higher plant reliability is also obtained. Failure of one gas turbine will not cause entire shut-down of the plant, since the load can be driven, though with a reduced power, by the gas turbine which remains operative.

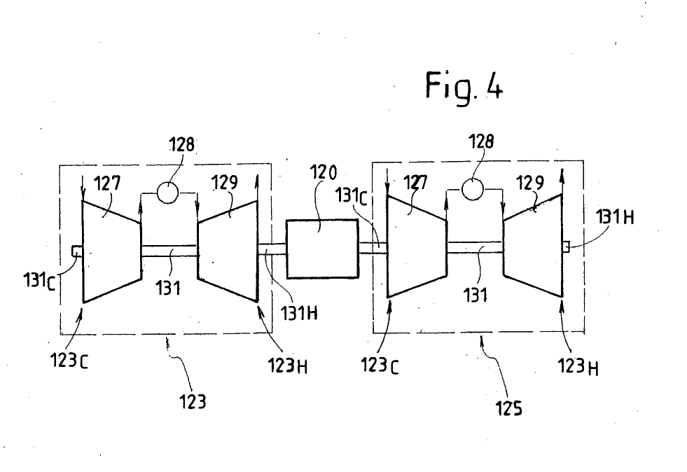

FIG. 4 schematically illustrates a further embodiment of the subject disclosed herein. In this embodiment a load 120 is driven by two main frame gas turbines 123 and 125. Each main frame gas turbine 123, 125 comprises a compressor 127 and a power turbine 129. The air compressed by compressor 127 flows in a combustor 128. The combustion gases generated in combustor 128 are expanded in the power turbine 129. The compressor 127 and the power turbine 129 are supported by and torsionally constrained to a common shaft 131. Each shaft 131 has a first end 131C at the cold side 123C, 125C of the respective gas turbine 123, 125 and a second end 131H at the hot side 123H, 125H of the respective gas turbine 123, 125. The second end 131H of shaft 131 of the first gas turbine 123 and the first end 131C at the cold side of the second gas turbine 125 are both connected to the common load 120. Power from the two gas turbines 123 and 125 is used in combination to drive the common load 120.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

What is claimed is:

1. A system for driving a variable load, the system comprising:
a first gas turbine comprising a first cold end and a first hot end;
a second gas turbine comprising a second cold end and a second hot end;
a plurality of clutch joints, wherein at least one clutch joint of the plurality of clutch joints mechanically connects the variable load at the first hot end of the first gas turbine, and at least a further clutch joint of the plurality of clutch joints mechanically connects the variable load at the second cold end of the second gas turbine; and
a control system arranged to control the plurality of clutch joints in order to regulate the mechanical power transmission from the first gas turbine and/or the second gas turbine and the variable load.

2. The system according to claim 1, wherein the the first gas turbine and the second gas turbine are substantially equal to one another.

3. The system according to claim 1, wherein the first gas turbine further comprises a first power shaft extending from the cold end to the second hot end thereof, and the second gas turbine further comprises a second power shaft extending from the second cold end to the second hot end thereof, wherein the first power shaft and the second power shaft are mechanically connected to said variable load through the plurality of clutch joints.

4. The system according to claim 3, wherein the first power shaft and the second power shaft rotate at a first rotational speed and the variable load rotates at a second rotational speed, the first rotational speed being substantially equal to the second rotational speed.

5. The system according to claim 3, wherein the first power shaft and the second power shaft are connected through the plurality of clutch joints to opposite ends of a variable load shaft.

6. The system according to claim 1, wherein the first gas turbine and second gas turbine are aero derivative gas turbines.

7. The system according to claim 1, wherein the first gas turbine and the second gas turbine comprise a respective gas generator comprising a gas generator shaft and a power shaft, the power shaft extending coaxially to the gas generator shaft.

8. The system according to claim 7, wherein the first gas turbine further comprises:
a low-pressure compressor;
a high-pressure compressor;
a combustor;
a high-pressure turbine; and
a low-pressure turbine,
wherein the low-pressure compressor and the low-pressure turbine are supported by and torsionally connected to the first power shaft.

9. The system according to claim 8, wherein the first power shaft extends coaxially through a first high-pressure compressor rotor of said first gas turbine.

10. The system according to claim 9, wherein the second gas turbine further comprises:
a low-pressure compressor;
a high-pressure compressor;
a combustor;
a high-pressure turbine; and
a low-pressure turbine,
wherein the low-pressure compressor and the low-pressure turbine are supported and torsionally connected to the second power shaft.

11. The system according to claim 10, wherein the second power shaft extends coaxially through a second high-pressure compressor rotor of the second gas turbine.

12. The system according to claim 1, wherein the first gas turbine, the second gas turbine, and the variable load are substantially coaxial to one another.

13. A method for driving a variable load by gas turbines, the method comprising:
providing a first gas turbine comprising a first hot end and a first cold end;
providing a second gas turbine comprising a second hot end and a second cold end;
providing a plurality of clutch joints arranged to connect or disconnect the first gas turbine and/or the second gas turbine to the variable load;
rotating the first gas turbine, the second gas turbine, and the variable load in a same rotation direction;
selectively driving the variable load with one of the first gas turbine and the second gas turbine, or with both of the first gas turbine and the second gas turbine; and
controlling the plurality of clutch joints.

14. The method according to claim 13, wherein the variable load, the first gas turbine, and the second gas turbine rotate at substantially the same rotational speed.

15. The system according to claim 3, wherein the first gas turbine and the second gas turbine are substantially equal to one another.

16. The system according to claim 4, wherein the first gas turbine and the second gas turbine are substantially equal to one another.

17. The system according to claim 5, wherein the first gas turbine and the second gas turbine are substantially equal to one another.

18. The system according to claim 7, wherein the first gas turbine and the second gas turbine are substantially equal to one another.

19. The system according to claim 4, wherein the first power shaft and the second power shaft are connected through the plurality of clutch joints to opposite ends of a variable load shaft.
